(19) United States
(12) Patent Application Publication
(10) Pub. No.: US 2014/0106035 A1
(43) Pub. Date: Apr. 17, 2014

(54) HEALTH-GIVING FOODSTUFF CONTAINING ETHYL ESTERS OF FATTY ACIDS, NAMELY OF LINEN OIL, AND METHOD FOR OBTAINING THE SAME

(71) Applicants: Tadeusz Stanislaw Zajac, Krakow (PL); Piotr Zajac, Krakow (PL); Zygmunt Zander, Olsztyn (PL); Lidia Bozena Zander, Olsztyn (PL); Fabian Julian Dajnowiec, Olsztyn (PL); Pawel Banaszczyk, Morag (PL)

(72) Inventors: Tadeusz Stanislaw Zajac, Krakow (PL); Piotr Zajac, Krakow (PL); Zygmunt Zander, Olsztyn (PL); Lidia Bozena Zander, Olsztyn (PL); Fabian Julian Dajnowiec, Olsztyn (PL); Pawel Banaszczyk, Morag (PL)

(73) Assignee: LeenLife Pharma S.A., Myslenice (PL)

(21) Appl. No.: 14/123,469

(22) PCT Filed: May 30, 2012
(86) PCT No.: PCT/PL2012/000041

§ 371 Date: Dec. 2, 2013

(30) Foreign Application Priority Data
May 30, 2011 (PL) P.395052

(51) Int. Cl. A23L 1/30

(52) U.S. Cl. CPC A23L 1/3008
USPC 426/103; 426/601

(57) ABSTRACT

The subject of invention is the health-giving foodstuff containing ethyl esters of fatty acids of linen oil or linen oil and fish oil, characterised in that it constitutes of microcapsules in form of powder, which contains, in a protein-carbohydrate matrix, a nutraceutical with bioactive ethyl esters of acids ALA, LA or ALA, LA, DHA, EPA with not more than 4 percent by weight addition of ethanol, based on at least 99.8% anhydrous pharmaceutical ethanol, in form of drops of diameter less than 2₁.1m. The nature of the invention is also a method for obtaining of the health-giving foodstuff containing ethyl esters of fatty acids, namely of linen oil or linen oil and fish oil, by mixing of ingredients, their homogenisation, drying, characterised by that after obtaining liquid protein-carbohydrate matrix, a nutraceutical containing bioactive ethyl esters of acids ALA, LA or ALA, LA, DHA, EPA is introduced into it, followed by carrying out of dispergation of ester phase by mechanical agitation until stable form of emulsion is obtained, which is then treated with two-steps and two-stages pressure homogenisation: in 1^{st} stage—at pressure of at least 20 MPa on the 1^{st} step and 4 MPa at the 2^{nd} step, and in 2^{nd} stage—at pressure of at least 30 MPa on the 1^{st} step and 10 MPa at the 2^{nd} step, whilst homogenisation during the 1^{st} stage is carried out in process coupled with thermal processing of the emulsion, which is then spray dried in atmosphere of temperature 160-190° C. in the inlet of to drying cabinet and the powder is dispensed in neutral gas atmosphere.

The subject of the invention is a health-giving foodstuff containing ethyl esters of fatty acids, namely of linen oil, and method for obtaining the same.

### BACKGROUND OF THE INVENTION

Polish patent no. PL201959 presents a method for obtaining of health-giving dairy products and health-giving food dairy product

The method consists in that after initial milk processing, specific for a defined product, there is added 3 to 10% of a milk-oil emulsion made of milk and oil composition containing polyunsaturated fatty acids, namely omega-3, preferably docosahexaenoic acid—DHA and/or eicosapentaenoic acid—EPA, to a prepared in known way raw material and/or a semi-finished dairy product suitable for a obtained product. The emulsion is homogenised at temperature 60-70° C. and pressure of at least 15 MPa. Polyunsaturated fatty acids are usually of natural origin. Then, there is added an anti-oxidative vitamins A, C, E composition in form of a solution and at amount justified by nutrition and physiology, followed by technological processing of the emulsion and the combination which is necessary for obtaining a defined product, and, depending on needs, there are added known additives, namely stabilising salts and thickeners, powdered milk and flavours at adequate stage of the product manufacturing.

The health-giving dairy product is characterised by that it contains the milk-oil emulsion prepared with oils containing polyunsaturated fatty acids, namely of omega-3 group, preferably of natural origin and it contains the composition of anti-oxidative vitamins, particularly A, C, E vitamins and known additives, particularly stabilising salts, thickeners, powdered milk and flavours at amounts justified by technology.

Polish patent description no PL203686 disclosures a feed additive, method for manufacturing of the feed additive, feed composition containing the feed additive and usage of the feed additive in feeds.

The feed additive containing chemical compounds with unsaturated acid radicals is characterised by that it contains fatty acids salts, at least of linen oil, with metals of 1 and/or 2 group of the periodical table or preferably NH₄⁺, in which ratio of salts of polyunsaturated fatty n-6 acids to n-3 ones is 0.1-1.0:1.

The method for obtaining of the feed additive consist in that a fat emulsion, preferably of linen oil in water, is treated with oxides or hydroxides of metals of 1 and/or 2 group of the periodic table or preferably with NH₄⁺ at room temperature, or preferably with NH₄⁺ at temperature elevated up to boiling point and at stoichiometric or larger amount of a metal oxide or hydroxide or ammonium hydroxide. Obtained precipitate is filtrated, washed out with water and dried, and the obtained fatty acids salts are incorporated into a final product, preferably together with anti-oxidants.

Feed composition with the feed additive, comprising of a feed and other nutritious products and/or other materials used in nutrition of commercial animal herds is characterised by that it contains from 4-12 percent by weight of the feed additive in a powdery form and which consist of fatty acids salts, at least of linen oil with metals of 1 and/or 2 group of the periodic table or preferably NH₄⁺, in which ratio of salts of n-6 polyunsaturated acids to n-3 ones is 0.1-1.0:1. The prepared composition for animals feeding with the feed additive contains polyunsaturated fatty acids and metal and/or ammonium salts of these fatty acids of n-6 to n-3 at ratio 2-6:1. The feed additive contains salts of conjugated linoleic acids with metals of 1 and/or 2 group of the periodic table or preferably NH₄⁺ at amount of 40 percent by weight of a dry mass of the feed additive.

Use of the feed additive in rearing animals at the end of fattening period with addition of the additive at amount of 4-12 percent by weight of a dry mass of the feed additive.

Polish patent application PL-386607 describes a nutritional additive, method for its manufacturing and the installation for implementation of this method, and the use of the nutritional additive manufactured by this method. The nutritional additive consists of active substances, particularly of polyunsaturated fatty acids in form of a concentrate of saturated and unsaturated ethyl esters of long-chain fatty acids, namely of linen oil. Furthermore the nutritional additive consist of active substances, namely polyunsaturated essential fatty acids in form of ethylamids of long-chain fatty acids, namely of linen oil. Also, the nutritional additive consist of active substances, namely of polyunsaturated fatty acids in form of a mixture of concentrate of ethyl esters of long-chain fatty acids, namely linen oil, and of ethylamids of long-chain fatty acids, namely of linen oil constitute the nutritional additive.

The method for obtaining of the nutritional additive consists in a process of transesterification of esters with glycerides of raw oil, namely linen oil with 16- to 18-fold excess of directly dehydrated, pharmaceutical ethanol (anhydrous) of concentration at least 99.8% and with a catalyser—ethanol solution of alkali metal hydroxide, for example of potassium hydroxide, conducted in oxygen-free atmosphere saturated with gaseous nitrogen up to balance state with protected clean in order to protect from humidity, carbon dioxide and atmosphere oxygen, at preferably room temperature by effective homogenisation of the reaction mixture resulting from mixing with ejectors supported by circulation pumps with protection of spherical conformation cis of fatty acids. Then, at least one-step distillation of unreacted ethanol is carried out under underpressure of at least 95 kPa and at maximal temperature of 80° C.—vapour condensation by a coat-like condenser and separation of the remaining mixture to ester and glycerol phases followed by purification of the ester phase undergoes further processing. The final product is dispensed and transferred to a warehouse.

### THE AIM OF THE INVENTION

The problem to be solved and the aim of the invention is to obtain of a health-giving foodstuff containing a concentrate of ethyl esters of fatty acids, namely of linen oil, as a nutraceutical, as well as development of its obtaining method.

Due to the fact that the ethyl esters are in form of oily, strongly hydrophobic liquid with specific taste and smell, which makes their use inconvenient, there has been considered a change of the ester form to a solid form—powder. It has been also considered an increase of nutritional value of a product and maintenance its health-giving properties.

It became necessary to ensure microbiological purity of the powder composed only of edible components and totally free of toxic substances.

It was found that the bioactivity and microbiological purity of ethyl esters of acids ALA and LA, or ALA, LA, DHA and EPA can be used.

### SUMMARY OF THE INVENTION

The aim and the problem of the invention is solved by the health-giving foodstuff containing ethyl esters of fatty acids of linen oil or linen oil and fish oil, characterised in that it constitutes of microcapsules in form of powder, which contains, in a protein-carbohydrate matrix, a nutraceutical with bioactive ethyl esters of acids ALA, LA or ALA, LA, DHA, EPA with not more than 4 percent by weight addition of ethanol based on at least 99.8% anhydrous pharmaceutical ethanol, in form of drops of diameter less than 2 μm.

Preferably, according to the invention, the microcapsules diameter is from 10-500 μm.

Preferably in the protein-carbohydrate matrix as proteins there are used protein concentrates, preferably a milk proteins concentrate with decreased lactose concentration, containing minimum 30 percent by weight of proteins and/or plant proteins concentrate, preferably soya proteins isolate.

Preferably, according to the invention, in the protein-carbohydrate matrix as carbohydrate there are used polysaccharides, preferably low-saccharification maltodextrin with DE index not higher than 15, preferably 7-13.

Preferably, according to the invention, the protein-carbohydrate matrix can contain minimal amount up to 5 percent by weight flavouring-colouring additives such as β-caroten, lemon juice, orange juice, aromas and colourings, vitamins, bio-elements and optionally, addition of soya lecithin up to 2 percent by weight.

The nature of the invention is also a method for obtaining of the health-giving foodstuff containing ethyl esters of fatty acids, namely of linen oil or linen oil and fish oil, by mixing of ingredients, their homogenisation, drying, characterised by that after obtaining liquid protein-carbohydrate matrix, a nutraceutical containing bioactive ethyl esters of acids ALA, LA or ALA, LA, DHA, EPA is introduced into it, followed by carrying out of dispergation of ester phase by mechanical agitation until stable form of emulsion is obtained, which is then treated with two-steps and two-stages pressure homogenisation: in 1^{st} stage—at pressure of at least 20 MPa on the 1^{st} step and 4 MPa at the 2^{nd} step, and in 2^{nd} stage—at pressure of at least 30 MPa on the 1^{st} step and 10 MPa at the 2^{nd} step, whilst homogenisation during the 1^{st} stage is carried out in process coupled with thermal processing of the emulsion, which is then spray dried in atmosphere of temperature 160-190° C. in the inlet of to drying cabinet and the powder is dispensed in neutral gas atmosphere.

Preferably, according to the invention, after homogenisation of the 1^{st} stage, and before homogenisation of the 2^{nd} stage, the emulsion is put aside for 6 hours, and after that is warmed up to 50-70° C.

Preferably, according to the invention, continuous phase of the emulsion is obtained by dissolving in water of temperature about 30° C. of matrix components, that is proteins and polysaccharides, followed by protein hydration and the nutraceutical is introduced, preferable after hydration of ingredients.

Preferably, according to the invention, protein hydration is carried out at temperature 25-35° C., preferable for 4 hours.

Preferably, according to the invention, pressure homogenisation of the emulsion in 1^{st} stage is carried out at pressure 20-25 MPa at the 1^{st} step and at pressure of 4-5 MPa at the 2^{nd} step, preferably at temperature of 50-70° C.

Preferably, according to the invention, during thermal processing the stable emulsion is warmed up to temperature about 50-65° C., pasteurised and cooled down to about 10° C.

Preferably, according to the invention, pressure homogenisation of the emulsion in the 2^{nd} stage is carried out at temperature of 40-70° C. and pressure of 30-60 MPa at the first step, preferable 50 MPa, and at pressure of 10-15 MPa at the second stage, preferably at temperature 50-70° C.

Preferably, according to the invention, during storage and dispensing of the health-giving foodstuff is carried out in neutral gas atmosphere, preferably of nitrogen.

The health-giving foodstuff in form of a powder is as well absorbed by living beings as nutraceutical as such, which can pelletized, encapsulated or use for production of butter, cheese, fermented dairy drinks, sausages, baker's goods, pastas, and in addition it has higher nutritive value as it is enriched by proteins and carbohydrates if microcapsules matrix. It creates more possibilities of its usage as a diet supplement/food supplement/enriched foodstuff as a component of substances both in liquid and solid form, because structure of inside allows its reproduction in form of emulsion, conveniently with concentration of the ingredients from 35-45%.

The nutraceutical structure and the health-giving foodstuff in form of microcapsules are presented on microscope pictures enclosed to this description.

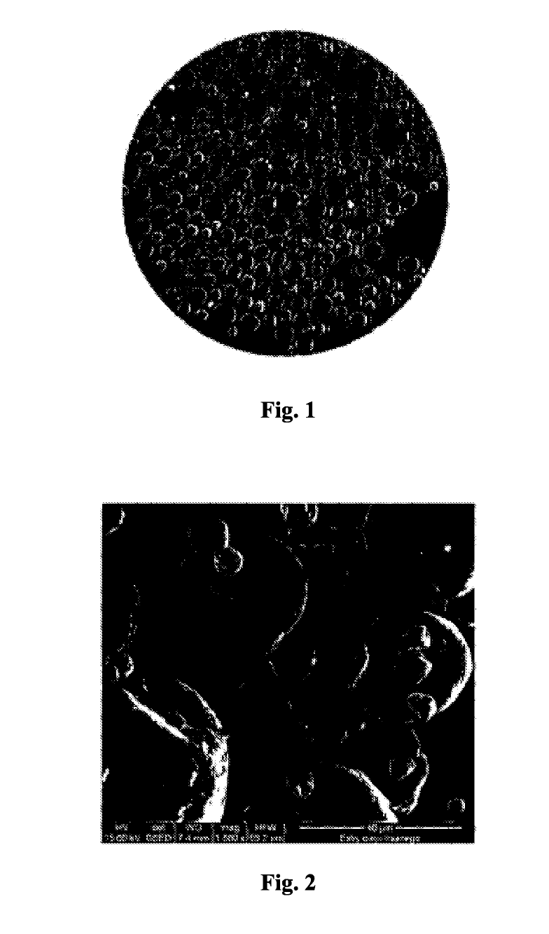

FIG. 1. It presents emulsion of ethyl esters of fatty acids of linen oil after repeated two-step pressure homogenisation—microcapsules after dissolving. Ester drops form a stable emulsion without tendency to coalescence, in spite of predisposition to flocculation. Diameter of the ester drops does not exceed 2 μm. The picture was taken from an optical microscope under magnification of 40×.

FIG. 2. It presents microcapsules in form of powder after spray drying of microcapsule dimensions 20-270 μm. The picture was taken with an electron microscope at magnification 1600×.

Microbiological quality of the health-giving foodstuff is comparable with powdered milk for babies. It has neutral taste and there is no smell specific for esters.

In the method according to this invention there are used only edible components of natural origin, and no emulsifiers obtained by chemical synthesis and in this way thermal and chemical disintegration of raw materials is avoided. As a consequence of two-stage and two-step pressure homogenisation there is achieved guaranty of closure of the bioactive substance—ethyl esters of acids ALA, LA or ALA, LA, DHA, EPA—inside structure of powder particles. Dehydration of microcapsules matrix by skilful spray drying makes impossible microorganisms growth inside the microcapsules as result of drastic decrease of water activity.

The inventions is closer explained in the examples showing composition of dry mass of the health-giving foodstuff expressed in percent by weight and method for obtaining the same.

### EXAMPLES

The subject of the invention is shown closer in preferred examples of its realisation.

The examples of realisation shall not be considered in any case as an exhaustive and limiting the presented inventions, and which nature has been characterised in patent claims.

### Example 1

1. low-saccharification maltodextrin DE 7-13 50.0 percent by weight

2. milk protein concentrate MPC 75 16,7 percent by weight

3. ethyl ester of acids ALA and LA 33,3 percent by weight

### Example 2

1. low-saccharification maltodextrin DE 7-13 34,0 percent by weight

2. milk protein concentrate MPC 75 36,0 percent by weight

3. ethyl ester of acids ALA, LA, DHA, EPA 30,0 percent by weight

### Example 3

1. low-saccharification maltodextrin 50,0 percent by weight

2. soya protein isolate 20,0 percent by weight

3. ethyl ester of acids ALA, LA 30,0 percent by weight

### Example 4

During mixing, to 40 dm³ of water warmed up to about 30° C. there are added 30.5 kg of low-saccharification maltodextrin DE 7-13, 10 kg of soya protein isolate and 25 dag of lecithin. After dispersing of the ingredients, the obtained emulsion is put aside for 5 hours at temperature of about 30° C. in order to protein hydration. Then, during the continuous mixing, there is added 19.5 kg ethyl esters available under commercial name LeenLife E and all of them is still mixing until stable emulsion is obtained. The obtained stable emulsion is thermally treated, which includes: warming up to temperature of 40° C., pasteurisation at 70° C., and cooling down to 9° C. in a cycle coupled with process of pressure homogenisation at temperature of about 50° C. at pressure about 23 MPa at the first step and about 5 MPa on the second step. After achieving drops of esters of diameter up to 6 μm, the emulsion is transferred to the 2^{nd} stage of the pressure homogenisation at pressure about 47 MPa at the first step and about 15 MPa at the second step. Then, after achieving drops of esters with a diameter up to 1 μm, the emulsion is directed to spray drying in a stream of hot air of temperature about 190° C. at inlet and about 90° C. at outlet of a dryer. There are obtained 58 kg of the health-giving foodstuff according to the invention.

### Example 5

During mixing, to 66 dm³ of water warmed up to temperature of about 35° C. there is added 18 kg of low-saccharification maltodextrin DE 7-13, 6.2 kg of milk protein concentrate MPC 75 and addition of 30 dag of lemon juice. After dissolution of the ingredients, the obtained emulsion is put aside for 3 hours at temperature of 30-20° C. in order to hydrate proteins. Then, during mixing, there is added 12.1 kg of ethyl esters available under brand name LeenLife E and there is carried out dispersion of ester phase by mixing. The obtained stabile emulsion is treated thermally: warming up to 45° C., pasteurisation 70° C. and cooling down to 10° C. in cycle coupled with the first stage of pressure homogenisation at temperature about 55° C. at pressure about 23 MPa at the first stage and about 4 MPa at the second stage. After achieving drops of a diameter less than 6 μm, the emulsion is left for 3 hours at temperature 10° C. After warming up to about 50° C., the emulsion is directed to pressure homogenisation at pressure 45 MPa at the first step and 14 MPa at the second step. Then, after achieving some drops of esters with a diameter smaller than 2 μm, the emulsion is transferred to spray drying at temperature about 170° C. at inlet and about 90° C. at outlet. There are obtained 36 kg of the health-giving foodstuff according to the invention.

### Example 6

During mixing, to water warmed up to about 30° C. there are added 34 kg of maltodextrin, 36 kg of sour-milk proteins concentrate WPC 80 and 0.3 kg of β-carotene. Water is used at amount allowing achieve emulsion containing 40% of a dry substance. Then the emulsion is put aside for 6 hours at temperature 25° C. in order to hydrate proteins, than there is added 30 kg of ethyl esters of acids ALA, LA, DHA EPA and it is stirred until stable emulsion of dispersed ester phase is achieved. Then the emulsion is treated thermally, including: warming, pasteurisation and cooling down to 10° C., coupled with 1^{st} stage of pressure homogenisation at temperature of about 50° C. and pressure 22 MPa at the first step and 3.5 MPa at the second step. As soon as ester drops of diameter below 6 μm are achieved, the emulsion undergoes 2^{nd} stage of pressure homogenisation at pressure of 47 MPa at the first step and 12 MPa at the second step. After achieving drops of diameter below 1.5 μm, the emulsion is spray dried in hot air of temperature about 180° C. at inlet and about 95° C. at outlet from the dryer cabinet. The dried product is dispensed in atmosphere of neutral gas, preferable of nitrogen, into paper bags with insert of plastic.

1. A health-giving foodstuff containing ethyl esters of fatty acids of linen oil or linen oil and fish oil, comprising microcapsules in form of powder, which contains, in a protein-carbohydrate matrix, a nutraceutical, in form of drops of diameter less than 2 μm, comprising with bioactive ethyl esters of acids ALA (alpha-linoleic acid, n-3), LA (linoleic acid, n-6) or ALA (alpha-linoleic acid, n-3), LA (linoleic acid, n-6), DHA docosahexaenoic acid, n-3), EPA (eicosapentaenoic acid, n-3), with not more than 4 percent by weight addition of ethanol, based on at least 99.8% anhydrous pharmaceutical ethanol.

2. The foodstuff according to claim 1, wherein the microcapsules have diameter in a range of from 10-500 μm.

3. The foodstuff according to claim 1, wherein in the protein-carbohydrate matrix as proteins there are used protein concentrates.

4. The foodstuff according to claim 1, wherein in the protein-carbohydrate matrix as carbohydrate there are used polysaccharides.

5. The foodstuff according to claim 1, wherein the protein-carbohydrate matrix contains up to 5 percent by weight flavoring-coloring additives and optionally, soya lecithin up to 2 percent by weight.

6. A method of making a health-giving foodstuff containing ethyl esters of fatty acids of linen oil or linen oil and fish oil, said method comprising:
providing a liquid protein-carbohydrate matrix, introducing a nutraceutical containing bioactive ethyl esters of acids ALA (alpha-linoleic acid, n-11, LA (linoleic acid, n-6) or ALA (alpha-linoleic acid, n-3), LA (linoleic acid, n-6), DHA docosahexaenoic acid, n-3), EPA (eicosapentaenoic acid, n-3), into the liquid protein-carbohydrate matrix, to form a nutraceutical-containing liquid protein-carbohydrate matrix, followed by
dispersing an ester phase of said nutraceutical-containing liquid protein-carbohydrate matrix by mechanical agitation until a stable form of emulsion is obtained,
treating the emulsion in a two-step, two-stage pressure homogenization process comprising a first stage homogenization conducted at pressure of at least 20 MPa in a first step and at least 4 MPa in a second step, and a second stage homogenization conducted at pressure of at least 30 MPa in a first step and at least 10 MPa in a second step, wherein homogenization during the first stage is carried with thermal processing of the emulsion,
spray drying the emulsion at temperature in a range of 160-190° C., to form a dry powder as said health-giving foodstuff.

7. The method according to claim 6, wherein after the first stage homogenization, and before the second stage homogenization, the emulsion is maintained without processing for 6 hours, and thereafter is warmed up to temperature in a range of 50-70° C.

8. The method according to claim 6, wherein a continuous phase of the emulsion is obtained by dissolving in water at temperature of about 30° C., matrix components comprising proteins and polysaccharides, followed by protein hydration and introduction of the nutraceutical.

9. The method according to claim 6, wherein the protein hydration is carried out at temperature in a range of 25-35° C.

10. The method according to claim 6, wherein the first stage homogenization of the emulsion is carried out at pressure in a range of 20-25 MPa in the first step and at pressure in a range of 4-5 MPa in the second step.

11. The method according to claim 6, wherein during thermal processing the stable emulsion is warmed up to temperature in a range of about 50-65° C., pasteurized and cooled down to temperature of about 10° C.

12. The method according to claim 6, wherein pressure homogenization of the emulsion in the second stage homogenization is carried out at temperature in a range of 40-70° C. and pressure in a range of 30-60 MPa in the first step, and at pressure in a range of 10-15 MPa a in the second step of the second stage homogenization.

13. The method according to claim 6, wherein the health-giving foodstuff is thereafter stored and dispensed in a neutral gas atmosphere.

14. The foodstuff according to claim 1, wherein the protein-carbohydrate matrix comprises at least one of milk proteins and soy proteins.

15. The foodstuff according to claim 4, wherein the polysaccharides comprise maltodextrin.

16. The foodstuff according to claim 5, wherein the flavoring-coloring additives comprise at least one additive selected from the group consisting of β-carotene, lemon juice, orange juice, aroma additives, coloring additives, vitamins, and bio-elements.

17. The method of claim 10, wherein the second step of the first stage homogenization is carried out at temperature in a range of 50-70° C.

18. The method of claim 12, wherein the first step of the second stage homogenization is carried out at pressure of 50 MPa.

19. The method of claim 12, wherein the second step of the second stage homogenization is carried out at temperature in a range of 50-70° C.

20. The method of claim 13, wherein the neutral gas atmosphere comprises nitrogen.
